(19) United States
(12) Patent Application Publication
(10) Pub. No.: US 2011/0019868 A1
(43) Pub. Date: Jan. 27, 2011

(54) Method for Image Positioning

(75) Inventors: Yen-Chu Chen, Guishan Shiang (TW); Kuo-Tung Kao, Guishan Shiang (TW); Hung-Sheng Tien, Guishan Shiang (TW); Chi-Bin Wu, Guishan Shiang (TW)

Correspondence Address: STITES & HARRISON PLLC, Suite 900, 1199 N. Fairfax Street, Alexandria, VA, 22314, US

(73) Assignee: AccuMIS Inc., Zhonghe City (TW)

(21) Appl. No.: 12/560,453

(22) Filed: Sep. 16, 2009

(30) Foreign Application Priority Data
Jul. 24, 2009 (TW) 098124966

(51) Int. Cl. G06K 9/00

(52) U.S. Cl. 382/100

(57) ABSTRACT

A method for image positioning is provided. The method is configured for positioning image data captured by a C-arm device and includes the steps of: providing an indication module, providing a database, reading the image data, comparing the image data, deriving a coordinate conversion system, and calculating the image data. Steel balls in the indication module have known template coordinates. Plural sets of template triangle data, each set composed by three of the steel balls, are stored in the database. Steel ball image data presented in the image data form indication triangle data. The indication triangle data are compared with the template triangle data to produce comparison results. The coordinate conversion system is derived from the comparison result with the highest similarity. Thus, image coordinates in the image data can be converted into and from the template coordinates via the coordinate conversion system, allowing the image to be orientated precisely.

### BACKGROUND OF THE INVENTION

1. Technical Field

The present invention relates to a method for image positioning and, more particularly, to a method for positioning an image captured by a C-arm device.

2. Description of Related Art

It is required in many surgical operations to implant certain fixing devices, such as screws, needles, and guide wires, into the human body. For the fixing devices to be implanted precisely at the right positions, the surgeon's experience is depended upon. In addition to that, the angles of related surgical instruments also influence the post-operative positional accuracy of the fixing devices, be they implanted along an axis of the pedicle, perpendicular to a bone surface, or otherwise.

Recently, computer-aided positioning techniques have been widely used to enhance the positioning precision during surgical operation. A surgeon can use proper medical imaging techniques to take images of a patient's lesion before the operation. The images taken are then re-constructed and re-combined by computer to produce three-dimensional images of the lesion. Afterward, coordinates are assigned to the three-dimensional images and input into a computer such that, during the operation, the computer provides guidance according to the input coordinates and increases the precision of intraoperative positioning significantly.

However, when a surgical operation is performed on an important part of the human body, it is still necessary to take real-time images of the lesion so as to determine the operating angles of surgical instruments accordingly and thereby ensure that the fixing devices implanted do not affect the surrounding healthy issues. This kind of image-assisted surgery, though more complex and more difficult than the conventional open surgery, requires smaller incision and thus achieves the effect of minimally invasive surgery, including accelerating postoperative recovery.

In order not to prolong the operation time, intraoperative imaging must be carried out by an imaging instrument that can display images promptly, such as those based on tomography and X rays. Besides rapid display of images, the imaging instrument must also be capable of taking images from different angles and being moved around conveniently. Therefore, the C-arm device, which is easily movable and angularly adjustable, is now the imaging instrument of choice in major medical institutions. Nevertheless, images taken by the C-arm device must be properly processed so as to determine the position of the lesion correctly and rapidly, thereby ensuring the positioning precision of the fixing devices being implanted.

While taking images, the C-arm device relies on an indication module to assist in positioning the images. A conventional indication module is provided with steel balls arranged in a right triangle such that the positions of the steel balls in an image taken can be used to determine the orientation of the image. However, if any one of the steel balls in the image is hidden, for example, by a bone structure, the image of the right triangle will not be formed, and in consequence the orientation of the image cannot be determined.

In view of the above, it is an issue demanding immediate attention to solve the aforesaid problems with image positioning and further increase the precision of image positioning.

### BRIEF SUMMARY OF THE INVENTION

It is an objective of the present invention to provide a method for image positioning, wherein template triangle data with known coordinates are compared with indication triangle data in image data so as to derive a coordinate conversion system and position the image data accordingly.

It is another objective of the present invention to provide a method for image positioning such that image coordinates can be converted into and from template coordinates via a coordinate conversion system, thereby increasing the precision of image positioning and qualifying the method of the present invention for use in a surgical navigation system.

It is yet another objective of the present invention to provide a method for image positioning such that image data include plural sets of indication triangle data. Thus, even if part of the image data is blocked from view, it is still possible to find one of the plural sets of indication triangle data in the remaining part of the image data for comparison, thereby reducing the difficulty of image positioning.

To achieve the above and other objectives, the present invention provides a method for image positioning, wherein the method is applicable to a C-arm device and is configured for positioning image data captured by the C-arm device. The method includes the steps of: providing an indication module, wherein the indication module includes at least three steel balls, of which each three steel balls form a triangle and each steel ball has a set of known template coordinates; providing a database for storing plural sets of template triangle data, wherein each set of the template triangle data is composed by three of the steel balls; reading the image data, wherein the image data include plural sets of steel ball image data, and each set of the steel ball image data corresponds to a corresponding one of the steel balls; comparing the image data by selecting at least three sets of the steel ball image data from the plural sets of steel ball image data so as to compose at least one set of indication triangle data and then comparing the at least one set of indication triangle data with the plural sets of template triangle data; deriving a coordinate conversion system from the comparison result with the highest similarity of all the comparison results obtained by comparing the at least one set of indication triangle data with the plural sets of template triangle data; and calculating the image data according to the coordinate conversion system so as to convert image coordinates into and from the template coordinates.

Implementation of the present invention at least involves the following inventive steps:

1. With the image data including the plural sets of indication triangle data, the image data can be positioned even if part of the image data is obscured.

2. With the coordinate conversion system being derived from the comparison result with the highest similarity that is obtained by comparing the template triangle data with the indication triangle data, the precision of image positioning is enhanced.

### BRIEF DESCRIPTION OF THE SEVERAL VIEWS OF THE DRAWINGS

A detailed description of further features and advantages of the present invention is given below, with a view to enabling a person skilled in the art to understand and implement the technical contents disclosed herein and to readily comprehend the objectives and advantages of the present invention by reviewing the following description and the appended claims in conjunction with the accompanying drawings, in which:

FIG. 1 is a flowchart of a method for image positioning according to the present invention;

FIG. 2 shows an embodiment of an indication module according to the present invention;

FIG. 3 shows an embodiment of a database according to the present invention;

FIG. 4 shows an embodiment of image data according to the present invention; and

FIG. 5 shows another embodiment of the image data according to the present invention.

### DETAILED DESCRIPTION OF THE INVENTION

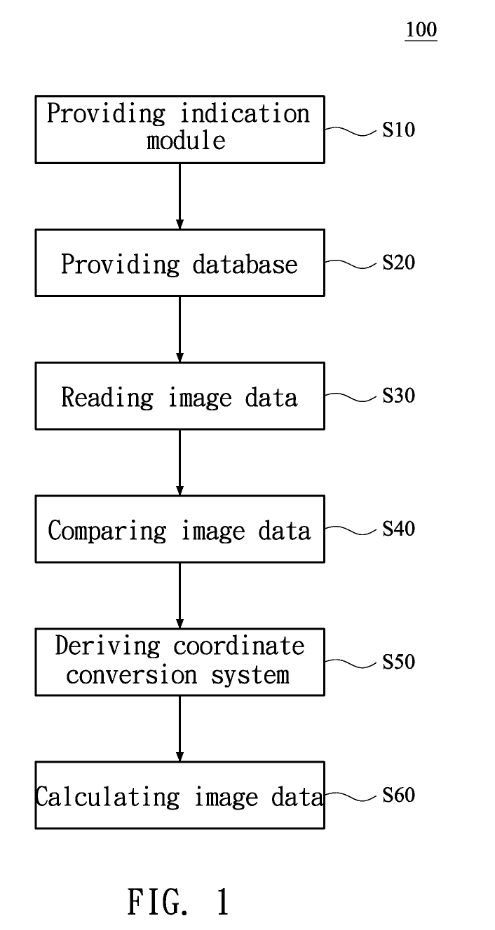

Referring to FIG. 1, a method for image positioning S100 according to an embodiment of the present invention is applicable to a C-arm device and configured for positioning image data 300 captured by the C-arm device. The method S100 includes the steps of: providing an indication module (S10), providing a database (S20), reading the image data (S30), comparing the image data (S40), deriving a coordinate conversion system (S50), and calculating the image data (S60).

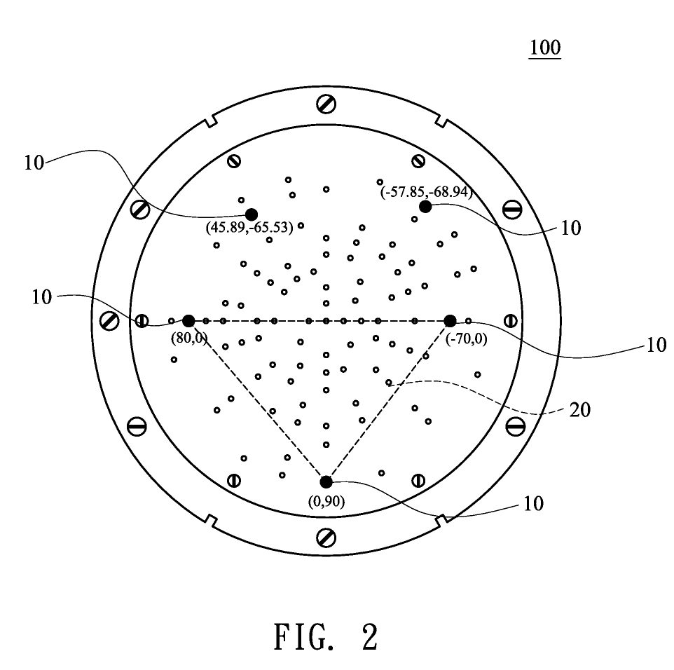

At the step of providing an indication module (S10), as shown in FIG. 2, an indication module 100 is provided which includes at least three steel balls 10. Each three of the at least three steel balls 10 form a triangle such that no three steel balls 10 in the indication module 100 are arranged in a straight line. Each three of the at least three steel balls 10 can form an oblique triangle. For example, each three of the at least three steel balls 10 can form an acute triangle or an obtuse triangle. The indication module 100 may include four, five, or more steel balls 10, wherein each steel ball 10 has a diameter of 6mm.

Referring to FIG. 2, there are five steel balls 10 arranged in the indication module 100. With each three steel balls 10 forming a template triangle 20, the five steel balls 10 altogether form ten different template triangles 20 in the indication module 100. Furthermore, each steel ball 10 has a set of known template coordinates, and the template coordinates of the steel balls 10 are recorded while they are arranged. For example, the template coordinates of the five steel balls 10 are: (−70, 0), (0, 90), (80, 0), (45.89, −65.53), and (−57.85, −68.94).

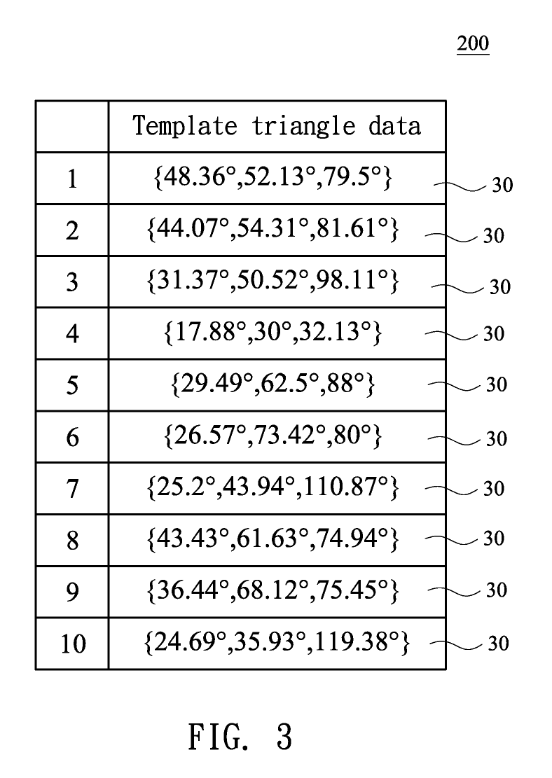

At the step of providing a database (S20), a database 200 is provided for storing plural sets of template triangle data 30, as shown in FIG. 3. Each set of the template triangle data 30 is provided by the template triangle 20 formed by three of the steel balls 10. Therefore, each set of the template triangle data 30 corresponds to one template triangle 20, and the three sets of template coordinates that compose the template triangle 20 can be obtained through the template triangle 20.

For instance, when the indication module 100 includes five steel balls 10, and the five steel balls 10 altogether form ten different template triangles 20, each of the template triangles 20 has its own set of template triangle data 30. More specifically, each set of the template triangle data 30 includes the measurements of three interior angles. Hence, stored in the database 200 are ten sets of template triangle data 30, each set including the measurements of three interior angles, such as {48.36°, 52.13°, 79.5°}, {44.07°, 54.31°, 81.61°}, {31.37°, 50.52°, 98.11°}, {17.88°, 30°, 132.13°}, {29.49°, 62.5°, 88°}, {26.57°, 73.42°, 80°}, {25.2°, 43.94°, 110.87°}, {43.43°, 61.63°, 74.94°}, {36.44°, 68.12°, 75.45°}, and {24.69°, 35.93°, 119.38°}.

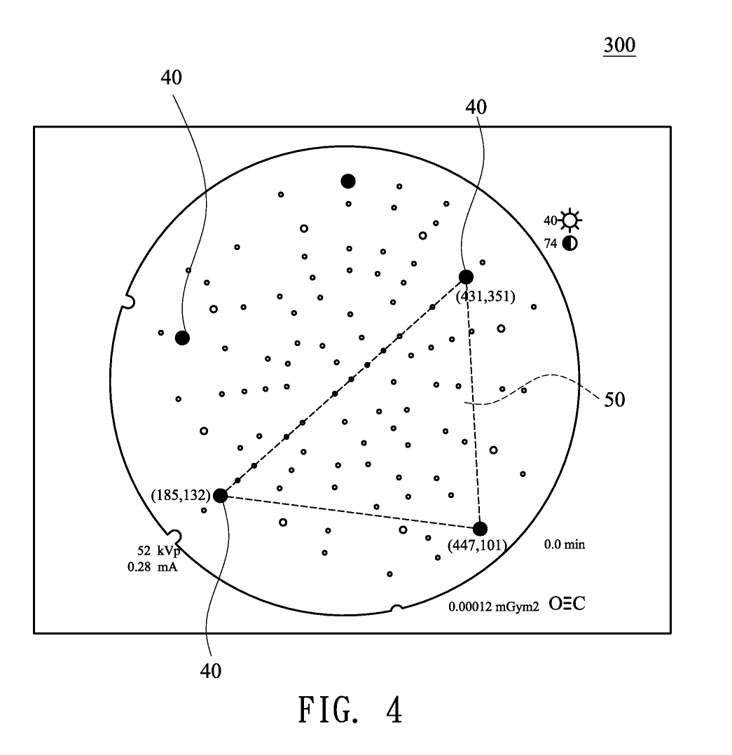

At the step of reading the image data (S30), the image data 300 captured by the C-arm device is read. Since the C-arm device captures images by placing the indication module 100 in front of an image probe, all the steel balls 10 in the indication module 100 are shown in the image data 300 read, as shown in FIG. 4. Consequently, the image data 300 include plural sets of steel ball image data 40, and each set of the steel ball image data 40 corresponds to a corresponding steel ball 10 in the indication module 100.

At the step of comparing the image data (S40), at least three sets of the steel ball image data 40 are selected from the plural sets of steel ball image data 40 in the image data 300, so as to compose at least one set of indication triangle data 50. Then, the at least one set of indication triangle data 50 is compared with the template triangle data 30 in the database 200. In order to locate each set of the steel ball image data 40 in the image data 300 correctly, the image data 300 can be calculated sequentially by a canny filter and an edge filter, thereby enhancing outline image data of each set of the steel ball image data 40 and removing blurred part of the outline image data.

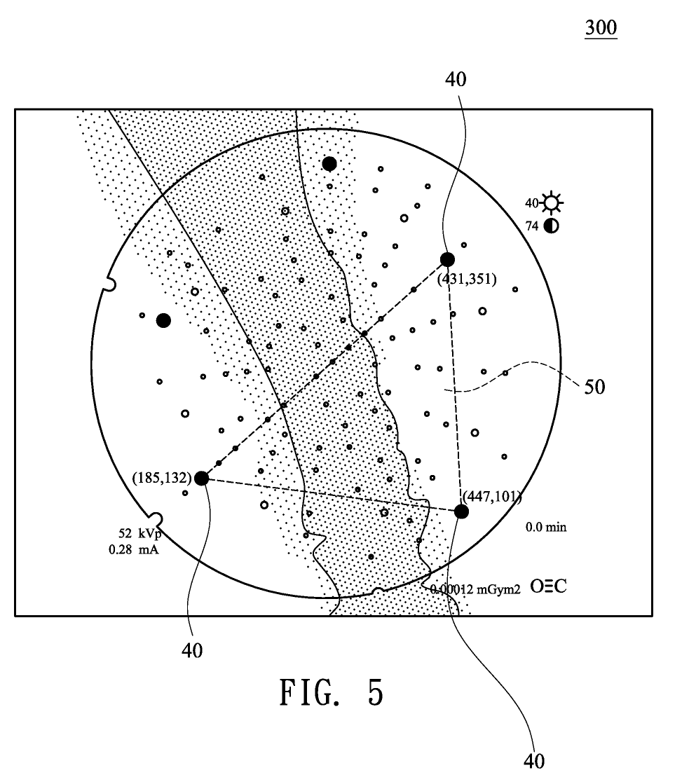

The steel ball image data 40 in the image data 300 may form plural sets of indication triangle data 50. In this case, each set of the indication triangle data 50 is compared against the database 200. Therefore, when a portion of the image data 300 is obscured, as shown in FIG. 5, at least one set of the indication triangle data 50 can still be composed by the remaining portion of the image data 300. In other words, the image data 300 can be positioned even if they are partially obscured.

At the step of deriving a coordinate conversion system (S50), the comparison result with the highest similarity of all the comparison results obtained by comparing the indication triangle data 50 in the image data 300 with the template triangle data 30 in the database 200 serves as the basis for deriving a coordinate conversion system.

For instance, if the comparison results show that the indication triangle data 50 bear the highest similarity to a particular set of the template triangle data 30, say {29.49°, 62.50°, 88°}, the template coordinates corresponding to this particular set of template triangle data 30 ({29.49°, 62.50°, 88°}) can be obtained, such as (−70, 0), (0, 90), and (80, 0). Meanwhile, image coordinates in the image data 300 that correspond to the indication triangle data 50 are, say, (431, 351), (447, 101), and (185, 132).

Thus, the coordinate conversion system can be derived from the template coordinates and the image coordinates obtained, using the following equation:

F_{img}=TFₜₑₘₚₗₐₜₑ

where F_{img} represents image coordinates, Fₜₑₘₚₗₐₜₑ represents template coordinates, and T represents the coordinate conversion system between the image coordinates and the template coordinates. According to the foregoing template coordinates and image coordinates, the coordinate conversion system (T) is derived as:

$$T = [ \begin{matrix}- 1.64 & 1.45 & 316.2 \\ - 1.46 & - 1.64 & 248.8 \\ 0 & 0 & 1\end{matrix} ]$$

At the step of calculating the image data (S60), the image data 300 captured by the C-arm device are calculated according to the coordinate conversion system derived from the previous step, so as to enable conversion between the image coordinates and the template coordinates in the indication module 100.

For instance, the template coordinates (10, 20) in the indication module 100 can be converted by way of the coordinate conversion system into the image coordinates (328.87, 201.36) in the image data 300. Likewise, the image coordinates in the image data 300 can be converted into the corresponding template coordinates.

In this way, each set of image coordinates in the image data 300 can be positioned by corresponding to a specific set of template coordinates in the indication module 100; by the same token, the template coordinates can also be positioned by corresponding to specific image coordinates. Hence, the method of image positioning according to the present invention can be applied to a surgical navigation system to increase the precision thereof.

The foregoing embodiments are illustrative of the characteristics of the present invention so as to enable a person skilled in the art to understand the disclosed subject matter and implement the present invention accordingly. The embodiments, however, are not intended to restrict the scope of the present invention. Hence, all equivalent modifications and variations made in the foregoing embodiments without departing from the spirit and principle of the present invention should fall within the scope of the appended claims.

What is claimed is:

1. A method for image positioning, wherein the method is applicable to a C-arm device and configured for positioning image data captured by the C-arm device, the method comprising steps of:
providing an indication module comprising at least three steel balls, wherein each three said steel balls form a triangle, and each said steel ball has a set of known template coordinates;
providing a database for storing plural sets of template triangle data, wherein each set of said template triangle data is composed by three said steel balls;
reading the image data, wherein the image data comprise plural sets of steel ball image data, and each set of said steel ball image data corresponds to a corresponding said steel ball;
comparing the image data by selecting at least three sets of said steel ball image data from the plural sets of steel ball image data so as to compose at least one set of indication triangle data and then comparing the at least one set of indication triangle data with the plural sets of template triangle data;
deriving a coordinate conversion system from a comparison result of the highest similarity of all comparison results obtained by comparing the at least one set of indication triangle data with the plural sets of template triangle data; and
calculating the image data according to the coordinate conversion system so as to enable conversion between image coordinates and the template coordinates.

2. The method of claim 1, wherein the indication module comprises four said steel balls.

3. The method of claim 1, wherein the indication module comprises five said steel balls.

4. The method of claim 1, wherein each said steel ball has a diameter of 6 mm.

5. The method of claim 1, wherein the triangle formed by each three said steel balls in the indication module is an oblique triangle.

6. The method of claim 5, wherein the triangle formed by each three said steel balls in the indication module is an acute triangle or an obtuse triangle.

7. The method of claim 1, wherein the image data is calculated by a canny filter so as to enhance outline image data of each set of said steel ball image data.

8. The method of claim 1, wherein the image data is calculated by an edge filter so as to remove an insignificant part of the outline image data of each set of said steel ball image data.
